(19) United States
(12) Patent Application Publication
(10) Pub. No.: US 2011/0010739 A1
(43) Pub. Date: Jan. 13, 2011

(54) METHOD AND APPARATUS FOR TRANSMITTING/RECEIVING STEREOSCOPIC VIDEO IN DIGITAL BROADCASTING SYSTEM

(75) Inventors: Kug-Jin YUN, Daejeon (KR); Hyun LEE, Daejeon (KR); Bong-Ho LEE, Daejeon (KR); Gwang-Soon LEE, Daejeon (KR); Nam-Ho HUR, Daejeon (KR); Kwang-Hee JUNG, Gyeonggi-do (KR); Jin-Woong KIM, Daejeon (KR); Soo-In LEE, Daejeon (KR); Heungsik PARK, Seoul (KR); Kyuheon KIM, Seoul (KR); Gwang-Hoon PARK, Gyeonggi-do (KR); Doug-Young SUH, Gyeonggi-do (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignees: Electronics and Telecommunications Research Institute, Daejon (KR); University-Industry Cooperation Group of Kyung Hee University, Gyeonggi-do (KR)

(21) Appl. No.: 12/831,579

(22) Filed: Jul. 7, 2010

(30) Foreign Application Priority Data
Jul. 7, 2009 (KR) 10-2009-0061562

(51) Int. Cl. H04N 13/00; H04N 5/445

(52) U.S. Cl. 725/39; 348/43; 348/E13.001

(57) ABSTRACT

Provided is a method for transmitting a stereoscopic video in a digital broadcasting system, the stereoscopic video being composed of a left view and a right view. The method includes: generating information indicating that the video is stereoscopic, information about a composition type of the stereoscopic video, and additional information based on the composition type; and transmitting the stereoscopic video and the generated information. The composition type is to compose the stereoscopic video of a single or two encoding streams by using the left view and the right view. In the case of a single stream mode in which the stereoscopic video is composed of the single encoding stream, the additional information includes information about positions of the left and right views. In the case of a dual stream mode in which the stereoscopic video is composed of the two encoding streams, the additional information includes information indicating whether the respective encoding streams are the left view or the right view and information indicating correlation between the respective encoding streams.

### CROSS-REFERENCE(S) TO RELATED APPLICATIONS

The present application claims priority of Korean Patent Application No(s). 10-2009-0061562 filed on Jul. 7, 2009 which is incorporated herein by reference in its entirety.

### BACKGROUND OF THE INVENTION

1. Field of the Invention

Exemplary embodiments of the present invention relate to a method and apparatus for transmitting/receiving a stereoscopic video in a digital broadcasting system.

2. Description of Related Art

FIG. 1 is a block diagram illustrating the architecture of a transmitter which transmits a two-dimensional (2D) video in a conventional digital broadcasting system. Referring to FIG. 1, a video encoder 12 encodes an inputted 2D video signal and generates a video Elementary Stream (ES). An audio encoder 14 encodes an inputted audio signal and generates an audio ES. The video ES and the audio ES generated from the video encoder 12 and the audio encoder 14 are inputted to a system encoder and multiplexing process unit 16. The system encoder and multiplexing process unit 16 includes a section generator 18, a Packetized Elementary Stream (PES) packetizer 20, a Transport Stream (TS) multiplexer 22, and a channel encoder 24.

The section generator 18 generates a Program Specific Information (PSI) section including basic information about a broadcasting program. The PES packetizer 20 receives the ESs generated from the video encoder 12 and the audio encoder 14, and converts the received ESs into PES packets. The PES packetizer 20 complies with the ISO/IEC 13818-1 systems standard. The TS multiplexer 22 multiplexes the PES packet and the PSI section into a Moving Picture Experts Group (MPEG)-2 TS. The TS is channel-encoded through the channel encoder 24 and then transmitted.

Unlike a 2D video, a stereoscopic video may be divided into a single stream mode, which is composed of a single ES, and a dual stream mode, which is composed of two ESs, depending on a composition type. Referring to FIG. 2, the stereoscopic video may be composed of a single ES as illustrated in FIGS. 2(A) to 2(D), or may be composed of two ESs as illustrated in FIG. 2(E).

As the stereoscopic video service has recently become an issue, there is a need to provide a stereoscopic video service to a user terminal while supporting the two stream modes, that is, the single stream mode and the dual stream mode.

### SUMMARY OF THE INVENTION

An embodiment of the present invention is directed to a method and apparatus for transmitting/receiving a stereoscopic video in a digital broadcasting system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for transmitting a stereoscopic video in a digital broadcasting system, the stereoscopic video being composed of a left view and a right view, includes: generating information indicating that the video is stereoscopic, information about a composition type of the stereoscopic video, and additional information based on the composition type; and transmitting the stereoscopic video and the generated information, wherein the composition type is to compose the stereoscopic video of a single or two encoding streams by using the left view and the right view, in the case of a single stream mode in which the stereoscopic video is composed of the single encoding stream, the additional information includes information about positions of the left and right views, and in the case of a dual stream mode in which the stereoscopic video is composed of the two encoding streams, the additional information includes information indicating whether the respective encoding streams are the left view or the right view and information indicating correlation between the respective encoding streams.

In accordance with another embodiment of the present invention, a method for receiving a stereoscopic video in a digital broadcasting system, the stereoscopic video being composed of a left view and a right view, includes: receiving the stereoscopic video, information indicating that the video is stereoscopic, information about a composition type of the stereoscopic video, and additional information based on the composition type; acquiring the stereoscopic video by using the additional information according to the composition type of the stereoscopic video; and reproducing the acquired stereoscopic video, wherein the composition type is to compose the stereoscopic video of a single or two encoding streams by using the left view and the right view, in the case of a single stream mode in which the stereoscopic video is composed of the single encoding stream, the additional information includes information about positions of the left and right views, and in the case of a dual stream mode in which the stereoscopic video is composed of the two encoding streams, the additional information includes information indicating whether the respective encoding streams are the left view or the right view and information indicating correlation between the respective encoding streams.

In accordance with another embodiment of the present invention, an apparatus for transmitting a stereoscopic video in a digital broadcasting system, the stereoscopic video being composed of a left view and a right view, includes: a stereoscopic video generation unit configured to generate the stereoscopic video according to a predetermined composition type; an information generation unit configured to generate information indicating that the video is stereoscopic, information about the composition type, and additional information about the stereoscopic video based on the composition type; and a transmission unit configured to transmit the generated stereoscopic video and the generated information, wherein the composition type is to compose the stereoscopic video of a single or two encoding streams by using the left view and the right view, in the case of a single stream mode in which the stereoscopic video is composed of the single encoding stream, the additional information includes information about positions of the left and right views, and in the case of a dual stream mode in which the stereoscopic video is composed of the two encoding streams, the additional information includes information indicating whether the respective encoding streams are the left view or the right view and information indicating correlation between the respective encoding streams.

In accordance with another embodiment of the present invention, an apparatus for receiving a stereoscopic video in a digital broadcasting system, the stereoscopic video being composed of a left view and a right view, includes: a reception unit configured to receive the stereoscopic video, information indicating that the video is stereoscopic, information about a composition type of the stereoscopic video, and additional information about the stereoscopic video based on the composition type; an information parsing unit configured to parse the information indicating that the video is stereoscopic, the information about the composition type of the stereoscopic video, and the additional information about the stereoscopic video based on the composition type; and a reproduction unit configured to reproduce the acquired stereoscopic video according to the information parsed by the information parsing unit, wherein the composition type is to compose the stereoscopic video of a single or two encoding streams by using the left view and the right view, in the case of a single stream mode in which the stereoscopic video is composed of the single encoding stream, the additional information includes information about positions of the left and right views, and in the case of a dual stream mode in which the stereoscopic video is composed of the two encoding streams, the additional information includes information indicating whether the respective encoding streams are the left view or the right view and information indicating correlation between the respective encoding streams.

### BRIEF DESCRIPTION OF THE DRAWINGS

FIG. 1 is a block diagram illustrating the architecture of a 2D transmitter in a conventional digital broadcasting system.

FIG. 2 is a view explaining a method for composing a stereoscopic video.

FIG. 3 is a flowchart illustrating a method for transmitting a stereoscopic video in accordance with an embodiment of the present invention.

FIG. 4 is a flowchart illustrating a method for receiving a stereoscopic video in accordance with an embodiment of the present invention.

FIG. 5 is a view illustrating a stereoscopic service descriptor in accordance with an embodiment of the present invention.

FIG. 6 is a view illustrating a stereoscopic object descriptor in accordance with an embodiment of the present invention.

FIG. 7 is a view illustrating a descriptor in a dual stream mode in accordance with an embodiment of the present invention.

FIG. 8 is a flowchart illustrating a method for receiving a stereoscopic video in accordance with another embodiment of the present invention.

FIG. 9 is a view explaining the method for receiving the stereoscopic video in accordance with the embodiment of the present invention.

FIG. 10 is a block diagram illustrating the architecture of an apparatus for transmitting a stereoscopic video in accordance with an embodiment of the present invention.

FIG. 11 is a block diagram illustrating the architecture of an apparatus for receiving a stereoscopic video in accordance with an embodiment of the present invention.

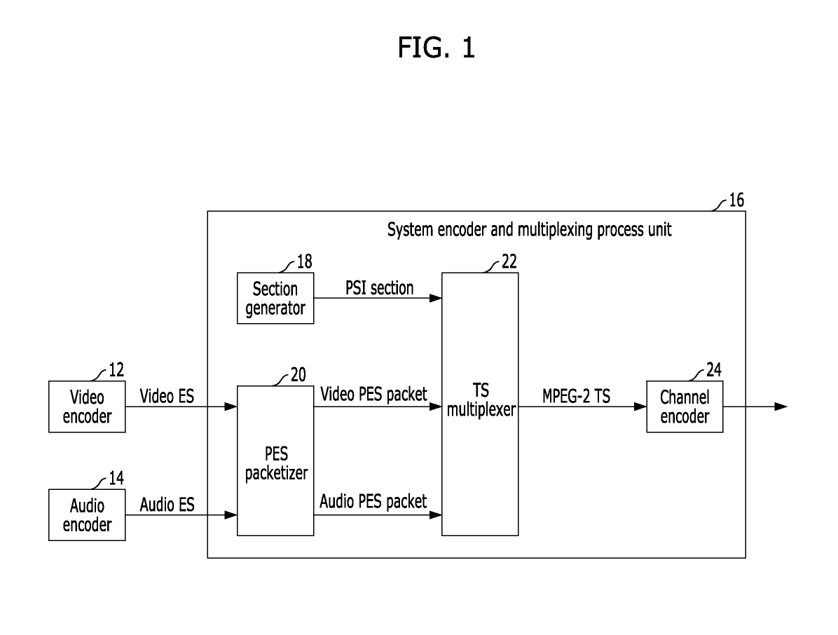

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

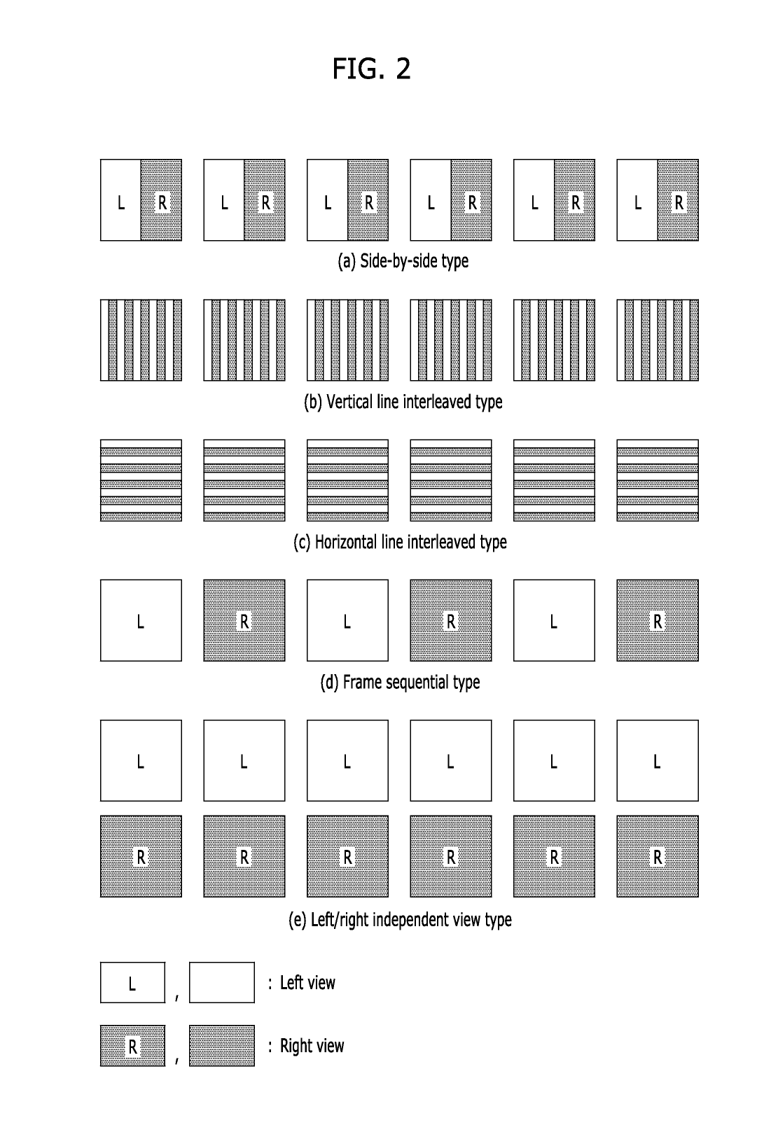

A method for composing a stereoscopic video will be described below with reference to FIG. 2.

A stereoscopic video may be divided into a single stream mode, which is composed of a single encoding stream, and a dual stream mode, which is composed of two encoding streams, depending on a composition type. The encoding stream refers to a stream generated by encoding one kind of data, such as video or audio. For example, the encoding stream may be an Elementary Stream (ES) in an MPEG.

As illustrated in FIGS. 2(A) to 2(D), the single stream mode refers to a video in which left and right views are composed of a single encoding stream as a video synthesized within a single frame through a composition type, such as a side-by-side type, a vertical line interleaved type, a horizontal line interleaved type, or a frame sequential type. As illustrated in FIG. 2(E), the dual stream mode refers to a video which is composed of two encoding streams generated by encoding left and right views independently or encoding through a cross reference.

In this embodiment, a base view refers to an image which is compatibly recognized and reproduced by a conventional 2D terminal, or an image which is reproduced when changing from a 3D reproduction mode to a 2D reproduction mode according to a user's command. An additional view refers to an image which has a different viewpoint from the base view. For example, when the base view is a left-eye image (a left view), the additional view may be a right-eye image (a right view). When the base view is a right-eye image (a right view), the additional view may be a left-eye image (a left view).

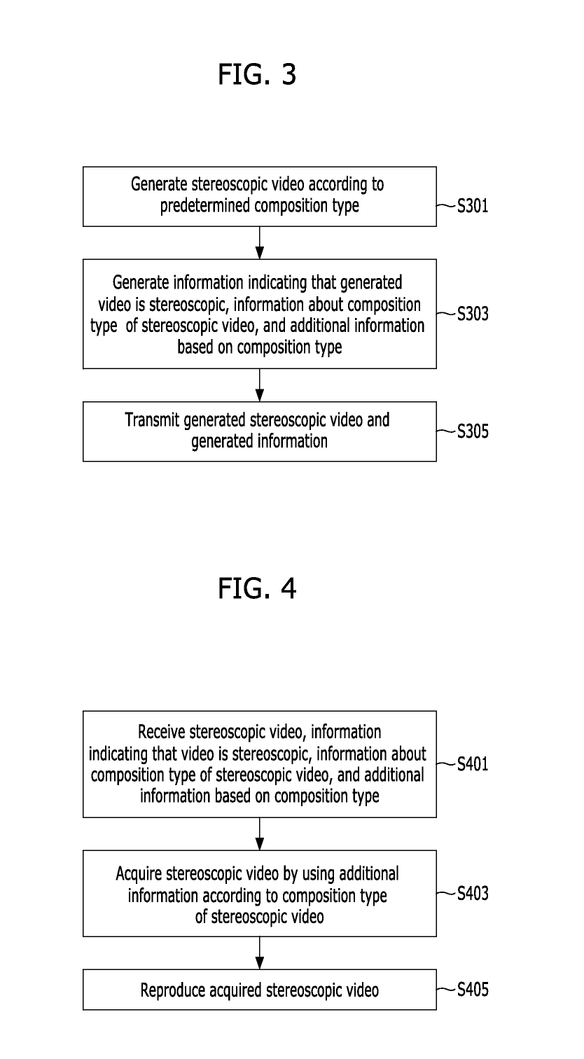

A method for transmitting a stereoscopic video in accordance with an embodiment of the present invention will be described below with reference to FIG. 3.

At step S301, an apparatus for transmitting a stereoscopic video generates a stereoscopic video according to a predetermined composition type. The composition type refers to a method of composing the stereoscopic video of a single or two encoding streams by using left and right views. For example, as described above, the stereoscopic video may be composed of a single encoding stream through the composition types of FIGS. 2(A) to 2(D), or the stereoscopic video may be composed of two encoding streams through the composition type of FIG. 2(E).

At step S303, the apparatus for transmitting the stereoscopic video generates information indicating that the generated video is stereoscopic, information about the composition type of the stereoscopic video, and additional information about the stereoscopic video based on the composition type. In the case of the single stream mode, the additional information about the stereoscopic video based on the composition type may include information about positions of the left and right views (information about the positions at which the left and right views are located within the single encoding stream). In the case of the dual stream mode, the additional information about the stereoscopic video based on the composition type may include information for identifying the base view and the additional view (information indicating whether the base view of the stereoscopic video to be transmitted is the left view or the right view), information for identifying the left view and the right view (information indicating whether the respective encoding streams are the left view or the right view), and information indicating the correlation between the respective encoding streams (information indicating whether the respective encoding streams are the base view or the additional view, and information indicating that the encoding stream of the base view and the encoding stream of the additional stream are a pair).

At this time, the information generated at the step S303 need not include all the described-above information in order to transmit the information to the reception side. In other words, some of the information indicating that the video generated at the step S301 is stereoscopic, the information about the composition type of the stereoscopic video, and the additional information about the stereoscopic video based on the composition type may be previously defined at both the transmission side and the reception side or may be used as defined in a separate protocol. As such, the information previously defined at both the transmission side and the reception side and the information defined in the separate protocol need not be transmitted from the transmission side to the reception side. For example, in the dual stream mode, in case where the information in which the left view (or the right view) is the base view is previously defined at both the transmission side and the reception side or previously defined in the separate protocol, the information for identifying the base view and the additional view need not be generated and transmitted at the step S303. The information generated at the step S303 will be described later in more detail.

At step S305, the apparatus for transmitting the stereoscopic video transmits the stereoscopic video generated at the step S301 and the information generated at the step S303. As one embodiment, a single or two encoding streams generated at the step S301 may be converted into PES packets, multiplexed together with the information generated at the step S303, and then transmitted in a TS form. It is apparent that the TS may be transmitted through a channel encoding. At this time, in the case of the dual stream mode, the two encoding streams may be transmitted through the same channel, or may be transmitted through separate channels. For example, in the latter case, the encoding stream of the base view (hereinafter, referred to as a “base view stream”) may be transmitted through a first channel, and the encoding stream of the additional view (hereinafter, referred to as an “additional view stream”) may be transmitted through a second channel.

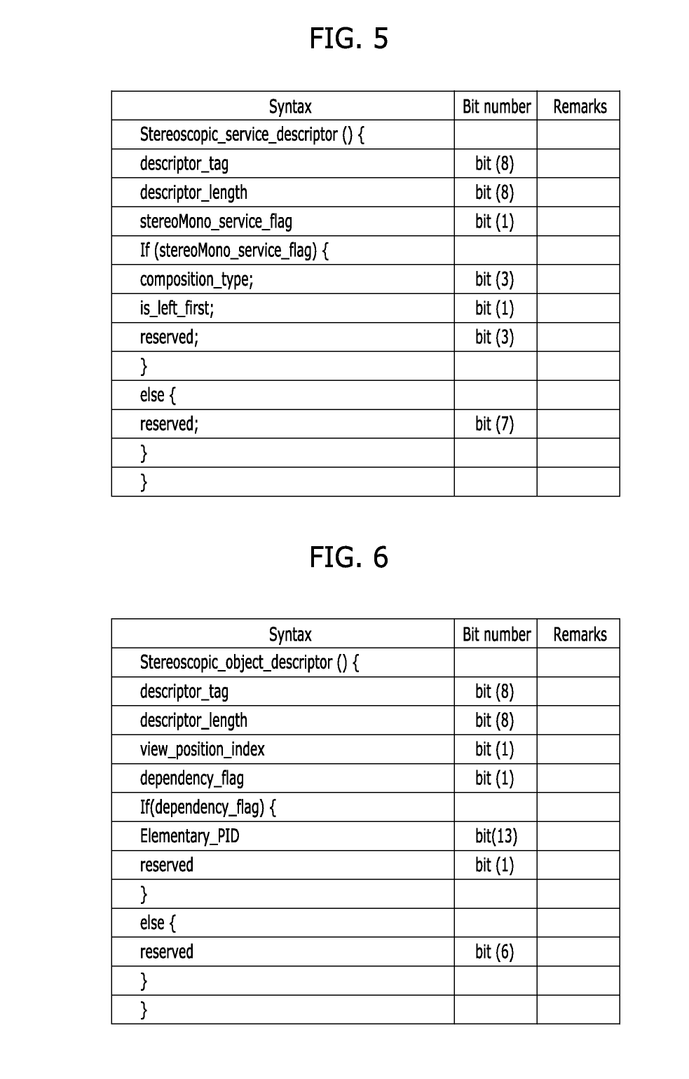

The information generated at the step S303 will be described with reference to embodiments of FIGS. 5 and 6.

In accordance with the embodiments of the present invention, a new descriptor may be defined in order to represent the information generated at the step S303. In FIG. 5, a descriptor including some of the information for identifying the stereoscopic video, the information about the composition type of the stereoscopic video, and additional information based on the composition type is defined as Stereoscopic_service_descriptor.

More specifically, descriptor_tag is an identifier indicating that the corresponding descriptor is a stereoscopic service descriptor. One of tag values defined as user private may be used as descriptor_tag. descriptor_length represents a length of the corresponding descriptor. descriptor_length may indicate a total length of the corresponding descriptor or a total length of subsequent fields.

stereoMono_service_flag indicates whether or not a video service to be transmitted to a terminal is a stereoscopic video service. For example, when stereoMono_service_flag has a value of 1, it may indicate that the video service to be transmitted to the terminal is the stereoscopic video service. As another embodiment, when the stereoscopic service descriptor (Stereoscopic_service_descriptor) exists, it may be considered that the video service to be transmitted to the terminal is the stereoscopic video service. Therefore, in this case, stereoMono_service_flag need not be separately defined.

composition type indicates the composition type of the stereoscopic video. For example, composition_type may be defined as Table 1 below. In Table 1 below, a case in which composition type has a value of 1 (001 in binary expression) to 4 (100 in binary expression) corresponds to the singe stream mode, and a case in which composition type has a value of 5 (101 in binary expression) corresponds to the dual stream mode.

TABLE 1

| Value | Composition type |
|---|---|
| 000 | Reserved |
| 001 | Side-by-side type |
| 010 | Vertical line interleaved type |
| 011 | Horizontal line interleaved type |
| 100 | Frame sequential type |
| 101 | Left/right independent view type |
| 110-111 | Reserved |

is_left_first represents information about the positions of the left and right views based on the composition type of the stereoscopic video or information for identifying the base view and the additional view. In the case of the single stream mode, is_left_first represents the positions of the left and right views. In the case of the dual stream mode, is_left_first represents whether the base view is the left view or the right view. As one embodiment, is_left_first may be defined as Table 2 below.

TABLE 2

| Composition | is_left_first = 1 | | is_left_first = 0 | |
|---|---|---|---|---|
| type | Left view | Right view | Left view | Right view |
| Side-by- | Left | Right | Right | Left |
| side type | | | | |
| Vertical | Odd line | Even line | Even line | Odd line |
| line | | | | |
| interleaved | | | | |
| type | | | | |
| Horizontal | Odd line | Even line | Even line | Odd line |
| line | | | | |
| interleaved | | | | |
| type | | | | |
| Frame | Odd frame | Even frame | Even frame | Odd frame |
| sequential | | | | |
| type | | | | |
| Left/right | Base view | Additional | Additional | Base view |
| independent | | view | view | |
| view type | | | | |

In FIG. 6, in the case of the dual stream mode, the descriptor including information for identifying the left and right views and information about the correlation between the respective encoding streams is defined as a stereoscopic object descriptor (Stereoscopic_object_descriptor) in accordance with an embodiment of the present invention. The stereoscopic object descriptor is generated with respect to the respective encoding streams of the dual stream mode.

More specifically, descriptor_tag is an identifier indicating that the corresponding descriptor is a stereoscopic object descriptor. One of tag values defined as user private may be used as descriptor_tag. descriptor_length represents a length of the corresponding descriptor. descriptor_length may represent a total length of the corresponding descriptor or a total length of subsequent fields.

view_position index identifies whether the corresponding encoding stream is the left view or the right view. In the case of the dual stream mode, which one of the left and right views is the base view can be known through the value of is_left_first included in the stereoscopic service descriptor (Stereoscopic_service_descriptor). However, which one of the two encoding streams is the left view or the right view cannot be identified. Therefore, such an identification can be achieved through view_position index.

dependency_flag identifies the independency or dependency of the left and right views. For example, when dependency_flag is 1, it represents that the corresponding encoding stream is a dependent stream. When dependency_flag is 0, it represents that the corresponding encoding stream is an independent stream. The dependent stream refers to an additional stream with respect to the independent stream. The independent stream refers to the base view stream. In another embodiment, dependency_flag may not be defined. Which one of the left and right view is the base view can be known through is_left_first included in the stereoscopic service descriptor (Stereoscopic_service_descriptor). Which one of the two encoding streams is the left view or the right view can be identified through view_position index included in the object descriptor (Stereoscopic_object_descriptor). Thus, it is possible to know which one of the two encoding streams is the base view stream.

Elementary_PID represents an identifier of the independent stream referenced by the dependent stream. That is, Elementary_PID refers to an identifier of the base view stream for referencing the base view stream in the additional view stream. Elementary_PID may is the information indicating that the two encoding streams are a pair in the dual stream mode and may be modified in various manners. For example, Elementary_PID may be a packet ID of the base view stream, an ID of the TS (TS_PID) including the base view stream, or an ID of a channel (Channel_ID) through which the base view stream is transmitted. Therefore, the correlation between the base view and the additional view is provided through Elementary_PID. Even though the stereoscopic video is composed of two encoding streams, it must be reconfigured and represented as a single three-dimensional video in the terminal. Thus, this is done for making it possible for the terminal to recognize the two encoding stream as a single object for stereoscopic video reproduction. In other words, the reception side may reproduce the stereoscopic video by matching the two encoding streams by using the value of Elementary_PID.

As another embodiment, Elementary_PID may be implemented as an identifier of the dependent stream referenced by the independent stream. Therefore, in this case, the identifier (Elementary_PID) of the additional view stream may be a packet ID of the additional view stream, an ID of the TS (TS_PID) including the additional view stream, or an ID of a channel (Channel_ID) through which the additional view stream is transmitted.

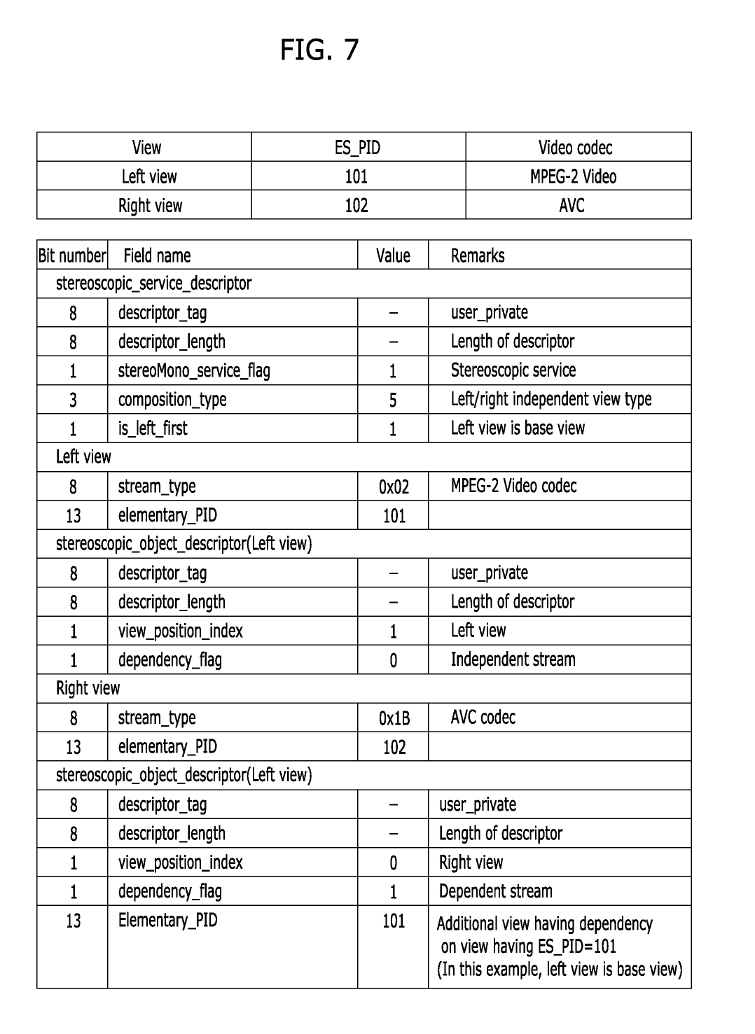

FIG. 7 is a view explaining the above-described descriptors in a Program Map Table (PMT) of a PSI when the stereoscopic video is composed of two encoding streams of the left and right independent views in accordance with an embodiment of the present invention.

Referring to FIG. 7, a packet ID (elementary_PID:ES_PID) of an encoding stream generated by encoding the left view in accordance with an MPEG-2 video codec is 101, and a packet ID of an encoding stream generated by encoding the right view in accordance with an Advanced Video Coding (AVC) codec is 102.

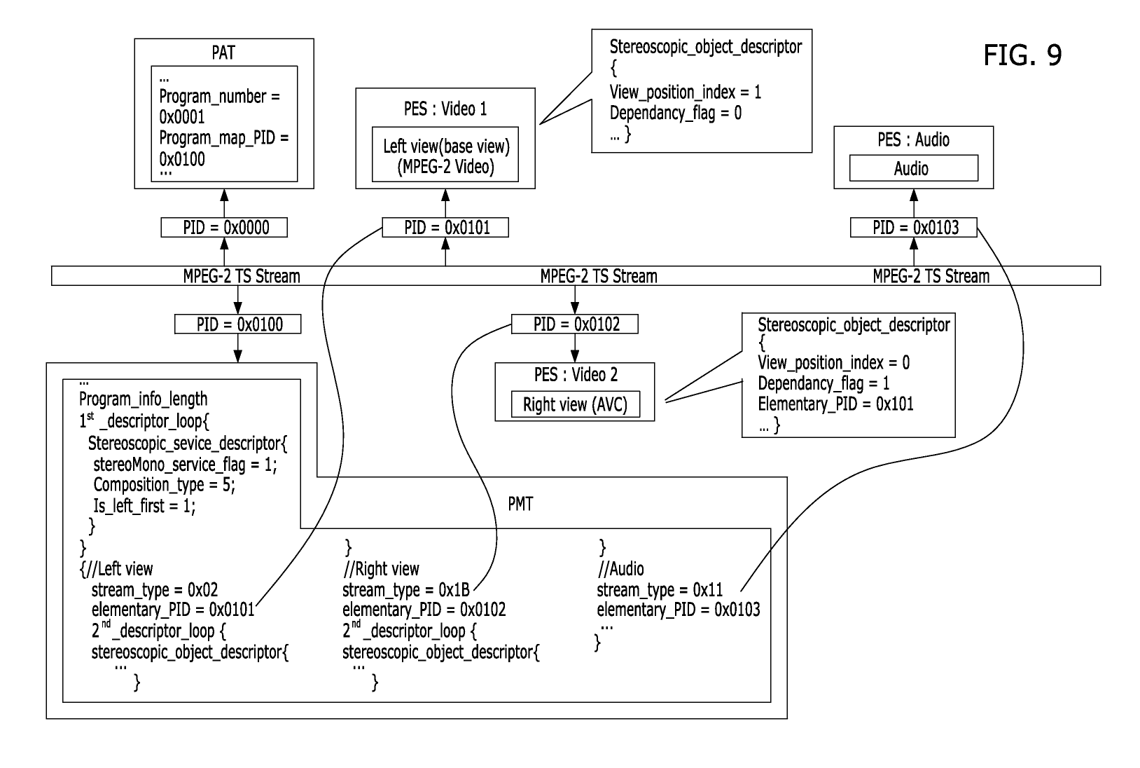

The stereoscopic service descriptor (Stereoscopic_service_descriptor) may be included in a descriptor just after Program_info_length included in the PMT (see FIG. 9).

The respective fields will be described below in more detail. “stereoMono_service_flag=1” represents the stereoscopic broadcasting. “composition_type=5” represents that the composition type of the stereoscopic video is composed of two encoding streams in which the left and right views are independent. “is_left_first=1” represents that the left view is the base view.

Since “composition_type=5”, it corresponds to the dual stream mode. Therefore, the stereoscopic object descriptor (Stereoscopic_object_descriptor) is included in a portion indicating information about the respective left/right view encoding streams. For example, the stereoscopic object descriptor (Stereoscopic_object_descriptor) may be positioned within the descriptor just after Elementary_PID indicating the characteristics of the respective encoding streams (see FIG. 9). In the case of the single stream mode, that is, composition_type is 1 to 4 (see Table 1), it is unnecessary to generate the stereoscopic object descriptor (Stereoscopic_object_descriptor).

Since the left view encoding stream uses the MPEG-2 video codec, stream_type and Elementary_PID are set to “stream_type=0x02” and “Elementary_PID=101”. Regarding the stereoscopic object descriptor (Stereoscopic_object_descriptor) for the left view encoding stream, it is represented that the corresponding encoding stream is the left view by setting “view_position_index=1”. In this manner, it is possible to identify that the encoding stream whose Elementary_PID is 101 corresponds to the left view and the base view, through the “is_left_first” field value of the stereoscopic service descriptor (Stereoscopic_service_descriptor) and the “view_position index” field value of the stereoscopic object descriptor (Stereoscopic_object_descriptor). Also, in the embodiment of FIG. 7, since the left view is the left view, that the corresponding encoding stream is the independent stream is represented by setting “dependency_flag=0”. As described above, in this embodiment, the independent stream represents that the corresponding encoding stream is the base view reproduced in the conventional terminal, and there exists the dependent stream related to the corresponding independent stream.

Since the right view encoding stream uses the AVC codec, stream_type and Elementary_PID are set to “stream_type=0x1B” and “Elementary_PID=102”. The stereoscopic object descriptor (Stereoscopic_object_descriptor) will be described in more detail. That the corresponding encoding stream is the right view is represented by setting “view_position_index=0”. At this time, since the right view is the additional view, that the corresponding encoding stream is the dependent stream is represented by setting “dependency_flag=1”, and Elementary_PID of the independent stream is represented by setting “Elementary_PID=101”. In this manner, the correlation that the encoding stream whose Elementary_PID is 101 and the encoding stream whose Elementary_PID is 102 are the base view stream and the additional view stream is represented. As another embodiment, as described above, the identifier of the additional view stream (Elementary_PID) may be set to “Elementary_PID=102” within the stereoscopic object descriptor (Stereoscopic_object_descriptor) regarding the base view stream (the left view encoding stream in FIG. 7). In this embodiment, the dependent stream may or may not be reproduced in the conventional codec. Thus, the dependent stream may be considered as additional data which are additionally required for three-dimensional reproduction.

In the case of the dual stream mode, the left and right streams may use the same codec (for example, left view: MPEG-2 video, right view: MPEG-2 video), depending on the service type. Like the embodiment of FIG. 7, the left and right streams may use a different codec. This provides the compatibility with the conventional digital broadcasting. In the case of the dedicated 3D broadcasting, the encoding may be performed using a variety of typical codecs.

The information generated at the step S303 may be used in the combination form as illustrated in FIGS. 5 and 6, and the information may be independently used. As such, the information may be used in various combination forms. The information having various combinations may be used while being included within the newly defined descriptor, as well as the above-described descriptors (the stereoscopic service descriptor and the stereoscopic object descriptor). Furthermore, as described above, some of the respective fields defined within the above-described descriptors (the stereoscopic service descriptor and the stereoscopic object descriptor) may be previously defined at both the transmission side and the reception side or may be previously defined in the separate protocol.

In this embodiment, the newly defined descriptor, including the above-described descriptors (the stereoscopic service descriptor and the stereoscopic object descriptor), may be used at different positions from those of the embodiment described with reference to FIG. 7. For example, the newly defined descriptor in accordance with the embodiment of the present invention may be transmitted while being included within one or more of a PMT of a PSI, an Event Information Table (EIT) and a Virtual Channel Table (VCT) of a Program and System Information Protocol (PSIP).

A method for receiving a stereoscopic video in accordance with an embodiment of the present invention will be described below with reference to FIG. 4.

At step S401, an apparatus for receiving a stereoscopic video receives stereoscopic video, information indicating that the received video is stereoscopic, information about the composition type of the stereoscopic video, and additional information about the stereoscopic video based on the composition type. As described above, in the case of the dual stream mode, the two encoding streams may be received through the same channel or may be received through separate channels. Also, as described above, in case where only some of the information indicating that the received video is stereoscopic, the information about the composition type of the stereoscopic video, and the additional information about the stereoscopic video based on the composition type are transmitted, only the transmitted information are received. Since the information received at the step S401 has been described above in detail, further description thereof will be omitted.

At step S403, the apparatus for receiving the stereoscopic video acquires the stereoscopic video by using the additional information about the stereoscopic video based on the composition type of the stereoscopic video. In the case of the single stream mode, the positions of the left and right views are known by using the received information. In the case of the dual stream mode, whether the base view of the received stereoscopic video is the left view or the right view, whether the respective encoding streams are the left view or the right view, and the correlation between the respective encoding streams are known by using the received information. In this manner, the apparatus for receiving the stereoscopic video may acquire the reproducible stereoscopic video. As described above, the information previously defined at both the transmission side and the reception side or previously defined in the separate protocol may be used.

At step S405, the apparatus for receiving the stereoscopic video reproduces the acquired stereoscopic video.

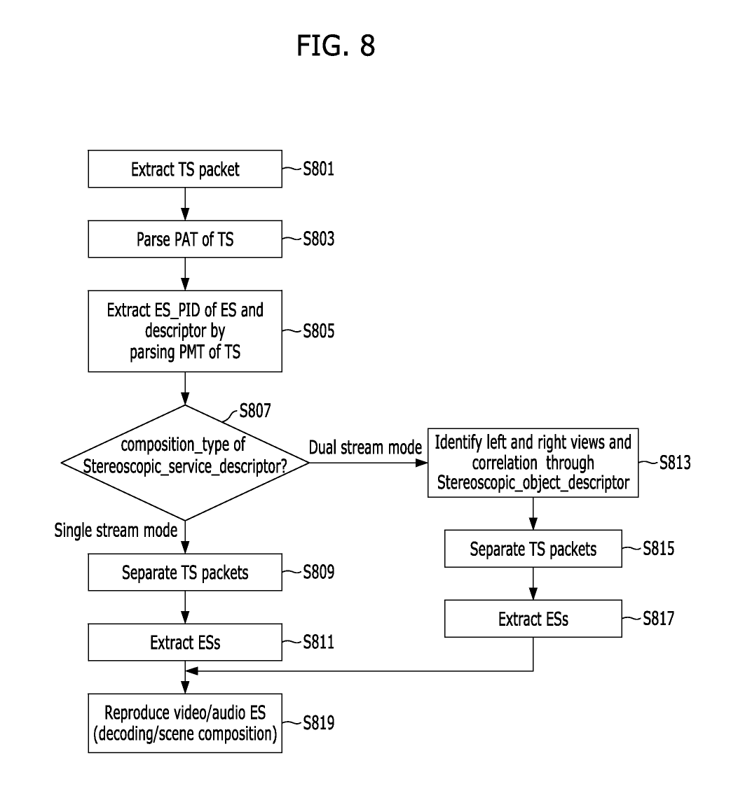

The steps S403 and S405 will be described below with reference to embodiments of FIGS. 8 and 9. FIG. 8 is a flowchart illustrating a method for receiving the stereoscopic video and acquiring the stereoscopic video through demultiplexing and decoding in accordance with an embodiment of the present invention. FIG. 9 is a view explaining a method for receiving the stereoscopic video of the dual stream mode and acquiring the stereoscopic video through demultiplexing and decoding in accordance with an embodiment of the present invention.

At step S801, the apparatus for receiving the stereoscopic video receives the TS multiplexed and transmitted by the transmitting apparatus, as described above at the step S305, and extracts a TS packet. At step S803, a program and a PID of the PMT of the program are found out by parsing PAT whose PID is 0x0000 within the TS. It can be seen from FIG. 9 that the PID (Program_map_PID) of the PMT is 0x0100.

At step S805, Elementary_PID (ES_PID) of the respective encoding streams (ES), the stream type (stream_type0), and the respective descriptors are extracted by parsing the PMT whose PID is 0x0100. The descriptor within the PMT is composed of two kinds of loops. A descriptor described in an upper level loop just after a program_info_length parameter within the PMT describes information about the entire program, and a descriptor described in a lower level loop describes information about the respective encoding streams (ES).

Referring to FIG. 9, the stereoscopic service descriptor (Stereoscopic_service_descriptor) in accordance with the embodiment of the present invention may be described in the upper level loop (1st_descriptor_loop) within the PMT. Through the stereoscopic service descriptor (Stereoscopic_service_descriptor), it is possible to identify whether the currently serviced broadcasting is 2D or 3D. Also, it is possible to identify the composition type of the stereoscopic video, the positions of the left and right views based on the composition type, or the base view and the additional view. Furthermore, the stereoscopic object descriptor (stereoscopic_object_descriptor) in accordance with the embodiment of the present invention may be described in the lower level loop (2nd_descriptor_loop) within the PMT. Based on the stereoscopic object descriptor (stereoscopic_object_descriptor), it is possible to identify the left and right views of the stereoscopic video in the dual stream mode and the correlation between the respective encoding streams. The field values of the stereoscopic service descriptor (Stereoscopic_service_descriptor) and the stereoscopic object descriptor (Stereoscopic_object_descriptor) illustrated in FIG. 9 are identical to those described above with reference to FIG. 7.

At step S807, the composition type of the stereoscopic video is determined through composition_type of the stereoscopic service descriptor (Stereoscopic_service_descriptor) among the descriptors extracted at the step S805.

At step S809, when it is determined that the stereoscopic video is the single stream mode (for example, when composition type_is 1 to 4), the respective TS packets are separated by using the information extracted at the step S805. At step S811, the respective ESs are extracted from the separated TS packets. For example, the stereoscopic video ES and audio ES of the single stream mode can be acquired.

At step S813, when it is determined that the stereoscopic video is the dual stream mode (for example, when composition_type is 5), the left and right views of the stereoscopic video and the correlation between the respective encoding streams can be identified through the stereoscopic object descriptor (Stereoscopic_object_descriptor). At step S815, the respective TS packets are separated by using the information extracted at the steps S805 and S813. At step S817, the respective ESs are extracted from the separated TS packets. For example, the left view video ES, right view video ES, and audio ES of the dual stream mode can be acquired.

At step S819, the apparatus for receiving the stereoscopic video reproduces the video ES and/or the audio ES acquired at the step S811 or S817. That is, the video signal and/or the audio signal are/is outputted by decoding the video ES and/or the audio ES.

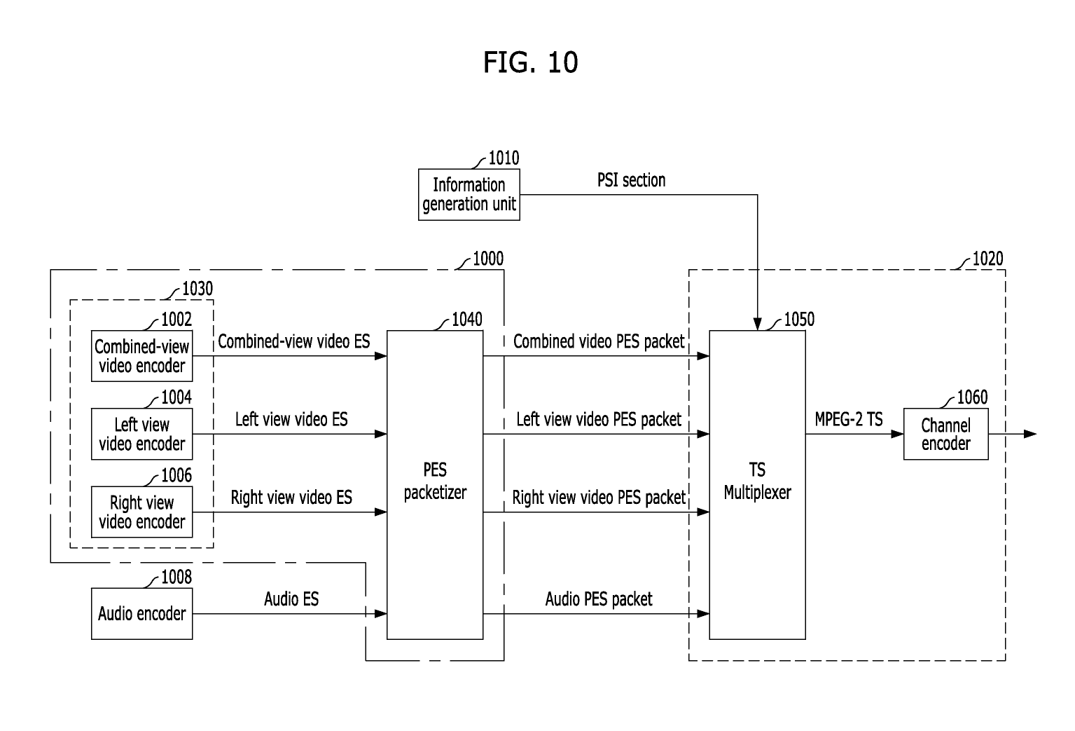

An apparatus for transmitting a stereoscopic video in accordance with an embodiment of the present invention will be described below with reference to FIG. 10. The apparatus for transmitting the stereoscopic video may include a stereoscopic video generation unit 1000, an information generation unit 1010, and a transmission unit 1020.

The stereoscopic video generation unit 1000 generates the stereoscopic video according to a predetermined composition type, and detailed description thereof is identical to that described above at the step S301 of FIG. 3.

As one modification example, the stereoscopic video generation unit 1000 may include a stereoscopic video encoder 1030 and a PES packetizer 1040.

The stereoscopic video encoder 1030 outputs one encoding stream or two encoding streams according to the composition type of the stereoscopic video. At this time, the stereoscopic video encoder 1030 may be provided with a combination of typical encoders or may be provided with a dedicated encoder. As one embodiment, the stereoscopic video encoder 1030 may include a combined-view video encoder 1002 to output the stereoscopic video as a single encoding stream. Also, the stereoscopic video encoder 1030 may include a left view video encoder 1004 and a right view video encoder 1006 to output the stereoscopic video as two encoding streams. Alternatively, the stereoscopic video encoder 1030 may include the combined-view video encoder 1002, the left view video encoder 1004, and the right view video encoder 1006 to output a single encoding stream or two encoding streams according to the composition of the left and right views and the codec.

The PES packetizer 1040 receives the encoding streams (ES) generated by the stereoscopic video encoder 1030 and/or an audio encoder 1008 and generates PES packets. The PES packetizer 1040 may comply with the ISO/IEC 13818-1 systems standard. In the dual stream mode, the PES packetizer 1040 inserts the same time stamp into a Decoding Time Stamp (DTS) or a Presentation Time Stamp (PTS) of the left and right videos in order for synchronization during the PES packetization. Also, a time stamp such as DTS or PTS may be inserted based on the same system clock in order for video (left and right videos in the dual stream mode) and audio synchronization.

The information generation unit 1010 generates information indicating that the video generated by the stereoscopic video generation unit 1000 is stereoscopic, information about the composition type of the stereoscopic video, and additional information about the stereoscopic video based on the composition type, and detailed description thereof is identical to that described above at the step S303 of FIG. 3. Also, when the information generated by the information generation unit 1010 is inserted into the PSI, it is outputted as section-format data (PSI section and the like).

The transmission unit 1020 transmits the generated stereoscopic video and the information generated by the information generation unit 1010 to the terminal, and detailed description thereof is identical to that described above at the step S305 of FIG. 3.

As one modification example, the transmission unit 1020 may include a TS multiplexer 1050 and a channel encoder 1030. The TS multiplexer 1050 multiplexes the PES packet and the information (for example, PSI section) generated by the information generation unit 1010 into MPEG-2 TS. The TS is channel-encoded through the channel encoder 1060 and then transmitted.

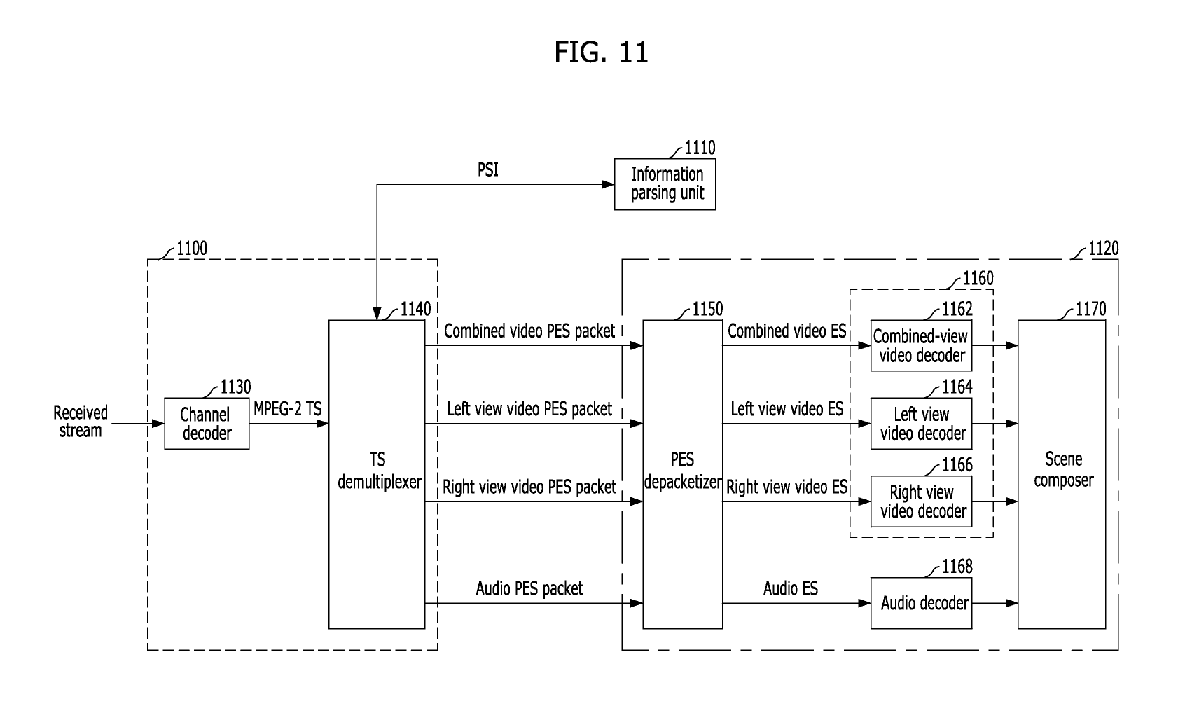

An apparatus for receiving a stereoscopic video in accordance with an embodiment of the present invention will be described below with reference to FIG. 11. The apparatus for receiving the stereoscopic video may include a reception unit 1100, an information parsing unit 1110, and a reproduction unit 1120.

The reception unit 1100 receives stereoscopic video, information indicating that the received video is stereoscopic, information about the composition type of the stereoscopic video, and additional information about the stereoscopic video based on the composition type, and detailed description thereof is identical to that described above at the step S401 of FIG. 4.

As one modification example, the reception unit 1100 may include a channel decoder 1130 and a TS demultiplexer 1140. The received TS is channel-decoded by the channel decoder 1130 and separated into PSI information and PES streams by the TS demultiplexer 1140. The PSI information is information about a program included within the PSI. The PSI information may include information indicating that the received video is stereoscopic, information about the composition type of the stereoscopic video, and additional information about the stereoscopic video based on the composition type.

The information parsing unit 1110 parses the information indicating the received video is stereoscopic, the information about the composition type of the stereoscopic video, and the additional information about the stereoscopic video based on the composition type. Since the meaning and parsing of such information has been described above, detailed description thereof will be omitted.

The reproduction unit 1120 reproduces the acquired stereoscopic video according to the information parsed by the information parsing unit 1110. In the dual stream mode, the transmitting apparatus previously inserts the same time stamp such as DTS or PTS into the left and right views, and the left and right views can be identified through the stereoscopic object descriptor (Stereoscopic_object_descriptor). Thus, the left and right views must be synchronized through an appropriate buffering. Likewise, the video (the left and right videos in the dual stream mode) and the audio must be also synchronized based on the inserted time stamp.

As one modification example, the reproduction unit 1120 may include a PES depacketizer 1150, a stereoscopic video decoder 1160, and a scene composer 1170.

The PES depacketizer 1150 receives the respective PES packets from the TS demultiplexer 1140, depacketizes the received PES packets, and outputs encoding streams (ES). A single or two video encoding streams outputted from the PES depacketizer 1150 are decoded by the stereoscopic video decoder 1160 and reproduced as stereoscopic videos by the scene composer 1170. Like the above-described stereoscopic video encoder 1030, the stereoscopic video decoder 1160 may include a combined-view video decoder 1162, or may include a left view video decoder 1164 and a right view video decoder 1166, or may include the combined-view video decoder 1162, the left view video decoder 1164, and the right view video decoder 1166. In case where the audio stream exists, the audio stream may be demultiplexed, depacketized and decoded and reproduced together with the stereoscopic video by the scene composer 1170.

In accordance with the embodiments of the present invention, the stereoscopic video service based on the composition type of the stereoscopic video may be provided. That is, when the stereoscopic video is composed of the single stream mode and the dual stream mode, the stereoscopic video service supporting the two modes may be provided. Thus, it is expected that the stereoscopic video

The above-described methods can also be embodied as computer programs and stored in computer-readable recording media, such as CDROMs, RAMs, ROMs, floppy disks, hard disks, optical magnetic disks, and so on. Since such procedures may be easily carried out by those skilled in the art, further detailed description thereof will be omitted.

While the present invention has been described with respect to the specific embodiments, it will be apparent to those skilled in the art that various changes and modifications may be made without departing from the spirit and scope of the invention as defined in the following claims.

What is claimed is:

1. A method for transmitting a stereoscopic video in a digital broadcasting system, the stereoscopic video being composed of a left view and a right view, the method comprising:
generating information indicating that the video is stereoscopic, information about a composition type of the stereoscopic video, and additional information based on the composition type; and
transmitting the stereoscopic video and the generated information,
wherein the composition type is to compose the stereoscopic video of a single or two encoding streams by using the left view and the right view,
in the case of a single stream mode in which the stereoscopic video is composed of the single encoding stream, the additional information comprises information about positions of the left and right views, and
in the case of a dual stream mode in which the stereoscopic video is composed of the two encoding streams, the additional information comprises information indicating whether the respective encoding streams are the left view or the right view and information indicating correlation between the respective encoding streams.

2. The method of claim 1, wherein the composition type is to compose the stereoscopic video of the single encoding stream by using any one of a side-by-side type, a vertical line interleaved type, a horizontal line interleaved type, and a frame sequential type.

3. The method of claim 1, wherein the information indicating that the video is stereoscopic, the information about the composition type of the stereoscopic video, and the additional information based on the composition type comprise one or more of a Program Map Table (PMT) of a Program Specific Information (PSI), a Virtual Channel Table (VCT) and an Event Information Table (EIT) of a Program and System Information Protocol (PSIP).

4. The method of claim 1, wherein the information indicating the correlation between the respective encoding streams comprises information indicating whether the respective encoding streams are a base view or an additional view, and information indicating that the two encoding streams are a pair.

5. The method of claim 1, wherein, in the case of the dual stream mode, the additional information further comprises information indicating whether a base view of the stereoscopic video is the left view or the right view,
the information indicating that the video is stereoscopic and the information about the composition type of the stereoscopic video are included in a first descriptor,
in the case of the single stream mode, the first descriptor further comprises information about positions of the left and right views,
in the case of the dual stream mode, the first descriptor further comprises information indicating whether a base view of the stereoscopic video is the left view or the right view,
in the case of the dual stream mode, a second descriptor is generated with respect to the two encoding streams,
the second descriptor comprises information indicating whether a corresponding encoding stream is the left view or the right view, and information indicating whether the corresponding encoding stream is a base view or an additional view,
the second descriptor generated with respect to the encoding stream of the additional view further comprises an identifier of the encoding stream of the base view,
the identifier of the encoding stream of the base view is any one of a packet ID of the encoding stream of the base view, an ID of a transport stream including the encoding stream of the base view, and an ID of a channel through which the encoding stream of the base view is transmitted.

6. A method for receiving a stereoscopic video in a digital broadcasting system, the stereoscopic video being composed of a left view and a right view, the method comprising:
receiving the stereoscopic video, information indicating that the video is stereoscopic, information about a composition type of the stereoscopic video, and additional information based on the composition type;
acquiring the stereoscopic video by using the additional information according to the composition type of the stereoscopic video; and
reproducing the acquired stereoscopic video,
wherein the composition type is to compose the stereoscopic video of a single or two encoding streams by using the left view and the right view,
in the case of a single stream mode in which the stereoscopic video is composed of the single encoding stream, the additional information comprises information about positions of the left and right views, and
in the case of a dual stream mode in which the stereoscopic video is composed of the two encoding streams, the additional information comprises information indicating whether the respective encoding streams are the left view or the right view and information indicating correlation between the respective encoding streams.

7. The method of claim 6, wherein the composition type is to compose the stereoscopic video of the single encoding stream by using any one of a side-by-side type, a vertical line interleaved type, a horizontal line interleaved type, and a frame sequential type.

8. The method of claim 6, wherein the information indicating that the video is stereoscopic, the information about the composition type of the stereoscopic video, and the additional information based on the composition type comprise one or more of a Program Map Table (PMT) of a Program Specific Information (PSI), a Virtual Channel Table (VCT) and an Event Information Table (EIT) of a Program and System Information Protocol (PSIP).

9. The method of claim 6, wherein the information indicating the correlation between the respective encoding streams comprises information indicating whether the respective encoding streams are a base view or an additional view, and information indicating that the two encoding streams are a pair.

10. The method of claim 6, wherein, in the case of the dual stream mode, the additional information further comprises information indicating whether a base view of the stereoscopic video is the left view or the right view,
the information indicating that the video is stereoscopic and the information about the composition type of the stereoscopic video are included in a first descriptor,
in the case of the single stream mode, the first descriptor further comprises information about positions of the left and right views,
in the case of the dual stream mode, the first descriptor further comprises information indicating whether a base view of the stereoscopic video is the left view or the right view,
in the case of the dual stream mode, a second descriptor is generated with respect to the two encoding streams,
the second descriptor comprises information indicating whether a corresponding encoding stream is the left view or the right view, and information indicating whether the corresponding encoding stream is a base view or an additional view,
the second descriptor generated with respect to the encoding stream of the additional view further comprises an identifier of the encoding stream of the base view,
the identifier of the encoding stream of the base view is any one of a packet ID of the encoding stream of the base view, an ID of a transport stream including the encoding stream of the base view, and an ID of a channel through which the encoding stream of the base view is transmitted.

11. An apparatus for transmitting a stereoscopic video in a digital broadcasting system, the stereoscopic video being composed of a left view and a right view, the apparatus comprising:
a stereoscopic video generation unit configured to generate the stereoscopic video according to a predetermined composition type;
an information generation unit configured to generate information indicating that the video is stereoscopic, information about the composition type, and additional information about the stereoscopic video based on the composition type; and
a transmission unit configured to transmit the generated stereoscopic video and the generated information,
wherein the composition type is to compose the stereoscopic video of a single or two encoding streams by using the left view and the right view,
in the case of a single stream mode in which the stereoscopic video is composed of the single encoding stream, the additional information comprises information about positions of the left and right views, and
in the case of a dual stream mode in which the stereoscopic video is composed of the two encoding streams, the additional information comprises information indicating whether the respective encoding streams are the left view or the right view and information indicating correlation between the respective encoding streams.

12. The apparatus of claim 11, wherein the composition type is to compose the stereoscopic video of the single encoding stream by using any one of a side-by-side type, a vertical line interleaved type, a horizontal line interleaved type, and a frame sequential type.

13. The apparatus of claim 11, wherein the information indicating that the video is stereoscopic, the information about the composition type, and the additional information about the stereoscopic video based on the composition type comprise one or more of a Program Map Table (PMT) of a Program Specific Information (PSI), a Virtual Channel Table (VCT) and an Event Information Table (EIT) of a Program and System Information Protocol (PSIP).

14. The apparatus of claim 11, wherein the information indicating the correlation between the respective encoding streams comprises information indicating whether the respective encoding streams are a base view or an additional view, and information indicating that the two encoding streams are a pair.

15. The apparatus of claim 11, wherein, in the case of the dual stream mode, the additional information further comprises information indicating whether a base view of the stereoscopic video is the left view or the right view, the information indicating that the video is stereoscopic and the information about the composition type are included in a first descriptor,
in the case of the single stream mode, the first descriptor further comprises information about positions of the left and right views,
in the case of the dual stream mode, the first descriptor further comprises information indicating whether a base view of the stereoscopic video is the left view or the right view,
in the case of the dual stream mode, a second descriptor is generated with respect to the two encoding streams,
the second descriptor comprises information indicating whether a corresponding encoding stream is the left view or the right view, and information indicating whether the corresponding encoding stream is a base view or an additional view,
the second descriptor generated with respect to the encoding stream of the additional view further comprises an identifier of the encoding stream of the base view,
the identifier of the encoding stream of the base view is any one of a packet ID of the encoding stream of the base view, an ID of a transport stream including the encoding stream of the base view, and an ID of a channel through which the encoding stream of the base view is transmitted.

16. An apparatus for receiving a stereoscopic video in a digital broadcasting system, the stereoscopic video being composed of a left view and a right view, the apparatus comprising:
a reception unit configured to receive the stereoscopic video, information indicating that the video is stereoscopic, information about a composition type of the stereoscopic video, and additional information about the stereoscopic video based on the composition type;
an information parsing unit configured to parse the information indicating that the video is stereoscopic, the information about the composition type of the stereoscopic video, and the additional information about the stereoscopic video based on the composition type; and
a reproduction unit configured to reproduce the acquired stereoscopic video according to the information parsed by the information parsing unit,
wherein the composition type is to compose the stereoscopic video of a single or two encoding streams by using the left view and the right view,
in the case of a single stream mode in which the stereoscopic video is composed of the single encoding stream, the additional information comprises information about positions of the left and right views, and
in the case of a dual stream mode in which the stereoscopic video is composed of the two encoding streams, the additional information comprises information indicating whether the respective encoding streams are the left view or the right view and information indicating correlation between the respective encoding streams.

17. The apparatus of claim 16, wherein the composition type is to compose the stereoscopic video of the single encoding stream by using any one of a side-by-side type, a vertical line interleaved type, a horizontal line interleaved type, and a frame sequential type.

18. The apparatus of claim 16, wherein the information indicating that the video is stereoscopic, the information about the composition type, and the additional information about the stereoscopic video based on the composition type comprise one or more of a Program Map Table (PMT) of a Program Specific Information (PSI), a Virtual Channel Table (VCT) and an Event Information Table (EIT) of a Program and System Information Protocol (PSIP).

19. The apparatus of claim 16, wherein the information indicating the correlation between the respective encoding streams comprises information indicating whether the respective encoding streams are a base view or an additional view, and information indicating that the two encoding streams are a pair.

20. The apparatus of claim 16, wherein, in the case of the dual stream mode, the additional information further comprises information indicating whether a base view of the stereoscopic video is the left view or the right view,
the information indicating that the video is stereoscopic and the information about the composition type are included in a first descriptor,
in the case of the single stream mode, the first descriptor further comprises information about positions of the left and right views,
in the case of the dual stream mode, the first descriptor further comprises information indicating whether a base view of the stereoscopic video is the left view or the right view,
in the case of the dual stream mode, a second descriptor is generated with respect to the two encoding streams,
the second descriptor comprises information indicating whether a corresponding encoding stream is the left view or the right view, and information indicating whether the corresponding encoding stream is a base view or an additional view,
the second descriptor generated with respect to the encoding stream of the additional view further comprises an identifier of the encoding stream of the base view,
the identifier of the encoding stream of the base view is any one of a packet ID of the encoding stream of the base view, an ID of a transport stream including the encoding stream of the base view, and an ID of a channel through which the encoding stream of the base view is transmitted.
